(19) United States
(12) Patent Application Publication
(10) Pub. No.: US 2023/0193664 A1
(43) Pub. Date: Jun. 22, 2023

(54) DOOR LATCH JAMMING ASSEMBLY

(71) Applicant: NISSAN NORTH AMERICA, INC., Franklin, TN (US)

(72) Inventor: David KOVIE, Livonia, MI (US)

(21) Appl. No.: 17/554,130

(22) Filed: Dec. 17, 2021

(51) Int. Cl. E05B 77/06; E05B 77/12; E05B 85/26

(52) U.S. Cl. CPC E05B 77/06; E05B 77/12; E05B 85/26

(57) ABSTRACT

A door latch jamming assembly includes a vehicle door assembly having an outer door panel, a latch mechanism and a jamming mechanism. The latch mechanism has a member movable between a door closed orientation and a door open orientation. The latch mechanism is installed to the vehicle door assembly inboard of the outer door panel. The jamming mechanism is installed to the latch mechanism. The jamming mechanism has a jamming member and an end portion coupled to the jamming member. The end portion extends away from the latch mechanism toward the outer door panel. In response to an impact event impacting forces press the outer door panel against the end portion pushing the end portion toward the latch mechanism. Consequently, the jamming member is also moved by the end portion into the latch mechanism preventing the member of the latch mechanism from moving away from the door closed orientation.

### BACKGROUND

### Technical Field

The present disclosure generally relates to a door latch jamming assembly. More specifically, the present disclosure relates to jamming assembly that includes a jamming member that moves into a door latch mechanism in response to a side impact event to a location within a door latch mechanism that prevents the door latch mechanism from operating to open a vehicle door.

### Background Information

During an impact event where impact energy is applied to a vehicle door, it is possible for the vehicle door to open in response to the impact energy.

### SUMMARY

One object of the present disclosure is to provide a vehicle door with a jamming member of a jamming assembly that moves into a door latch mechanism in response to a side impact event to a location within a door latch mechanism that prevents the door latch mechanism from operating to open a vehicle door.

In view of the state of the known technology, one aspect of the present disclosure is to provide a door latch jamming assembly that includes a vehicle door assembly, a latch mechanism and a jamming mechanism. The vehicle door assembly has an outer door panel. The latch mechanism has at least one member movable between a door closed orientation and a door open orientation. The latch mechanism is installed to the vehicle door assembly inboard of the outer door panel. The jamming mechanism is installed to the latch mechanism. The jamming mechanism has a jamming member and an end portion coupled to the jamming member. The end portion extends away from the latch mechanism toward the outer door panel such that in response to an impact event where impacting forces press the outer door panel against the end portion pushes the end portion toward the latch mechanism. The jamming member is also moved by the end portion into the latch mechanism preventing the member of the latch mechanism from moving away from the door closed orientation.

### BRIEF DESCRIPTION OF THE DRAWINGS

Referring now to the attached drawings which form a part of this original disclosure:

FIG. 1 is a perspective view of a vehicle having a vehicle door assembly that includes a latch mechanism and a jamming mechanism in accordance with a first embodiment;

FIG. 2 is a side view of the vehicle showing a striker (in phantom) attached to a B-pillar of the vehicle along with the vehicle door assembly with the latch mechanism and the jamming mechanism in phantom in accordance with the first embodiment;

FIG. 3 is a cross-sectional view of the vehicle door assembly taken along the line 3-3 in FIG. 2 showing the latch mechanism and the jamming mechanism in accordance with the first embodiment;

FIG. 4 is a perspective view of the vehicle door assembly showing the latch mechanism and the jamming mechanism in accordance with the first embodiment;

FIG. 5 is an end view of the latch mechanism with a portion of a housing of the latch mechanism removed showing a first moveable member and a second moveable member in a door open orientation with the striker released from the second moveable member in accordance with the first embodiment;

FIG. 6 is another end view of the latch mechanism similar to FIG. 5 showing the first moveable member and the second moveable member in a door closed orientation with the striker being held by the second moveable member in accordance with the first embodiment;

FIG. 7 is a cross-sectional view of the jamming mechanism showing a portion of the latch mechanism, a housing of the jamming mechanism and a jamming member and end portion formed as a single element biased by a spring in an at rest orientation in accordance with the first embodiment;

FIG. 8 is another cross-sectional view of the jamming mechanism showing the portion of the latch mechanism, the housing of the jamming mechanism and a jamming member and end portion moved in an inboard direction by impacting forces such that the spring is compressed and the jamming member is pushed into the latch mechanism preventing the first and second moveable members from moving (as shown in FIG. 6) in accordance with the first embodiment;

FIG. 9 is a cross-sectional view of a jamming mechanism having a housing fixed in position by the latch mechanism, a jamming member, an end portion and an adjustment structure that connects the jamming member to the end portion, the jamming mechanism being biased by a spring in an at rest orientation in accordance with a second embodiment;

FIG. 10 is a second cross-sectional view of the jamming mechanism with the jamming member, the adjustment structure and the end portion moved in an inboard direction by impact forces such that the spring is compressed and the jamming member is pushed into the latch mechanism preventing the first and second moveable members from moving (as shown in FIG. 6) in accordance with the second embodiment;

FIG. 11 is a third cross-sectional view of the jamming mechanism with the position of the end portion relative to a distal end of the jamming member changed by rotation of the end portion about the jamming member (use of the adjustment structure) such that a gap between an outboard surface of the end portion and the outer door panel is changed to a desired size in accordance with the second embodiment;

FIG. 12 is a cross-sectional view of a jamming mechanism showing a jamming member and an end portion with a first adjustment structure that connects the jamming member to the end portion, and a housing with a second adjustment structure that connects the housing to the latch mechanism with the jamming member and the end portion being biased by a spring to an at rest orientation in accordance with a third embodiment;

FIG. 13 is a second cross-sectional view of the jamming mechanism with the position of the end portion relative to a distal end of the jamming member changed by rotation of the end portion about the jamming member (use of the first adjustment structure) such that a distance between an outboard surface of the end portion and the latch mechanism is changed to a desired size relative to that shown in FIG. 12 in accordance with the third embodiment; and

FIG. 14 is a third cross-sectional view of the jamming mechanism with the position of the housing of the jamming mechanism relative to the latch mechanism being changed by rotation of the housing about an attachment portion of the latch mechanism (use of the second adjustment structure) such that the distance between an outboard surface of the end portion and the latch mechanism is changed to a desired size and the location of a distal end of the jamming member relative to the latch mechanism is also changed in accordance with the third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

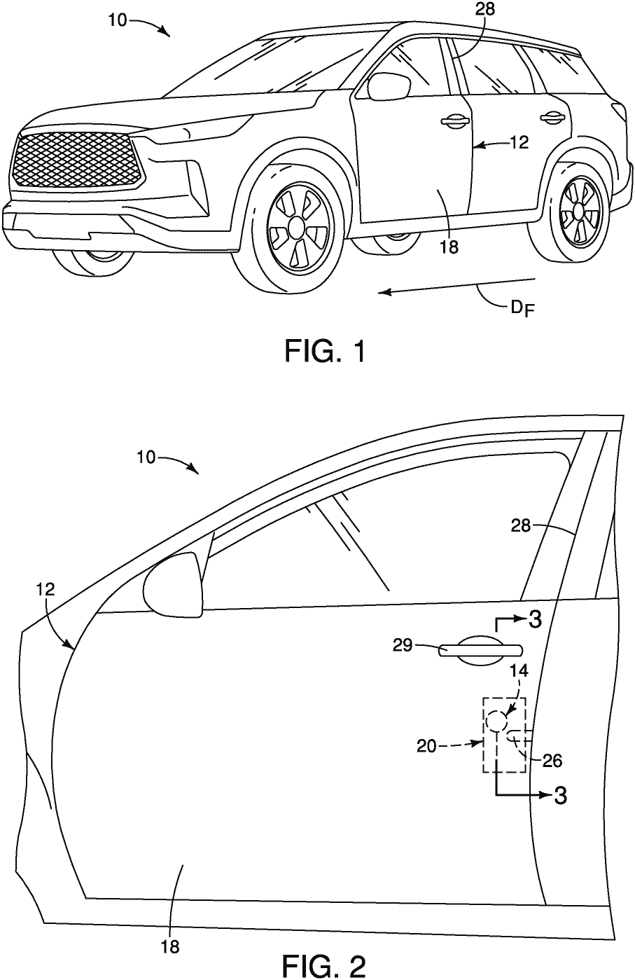

Referring initially to FIGS. 1, 2 and 3, a vehicle 10 having a vehicle door assembly 12 with a door latch jamming assembly 14 is illustrated in accordance with a first embodiment.

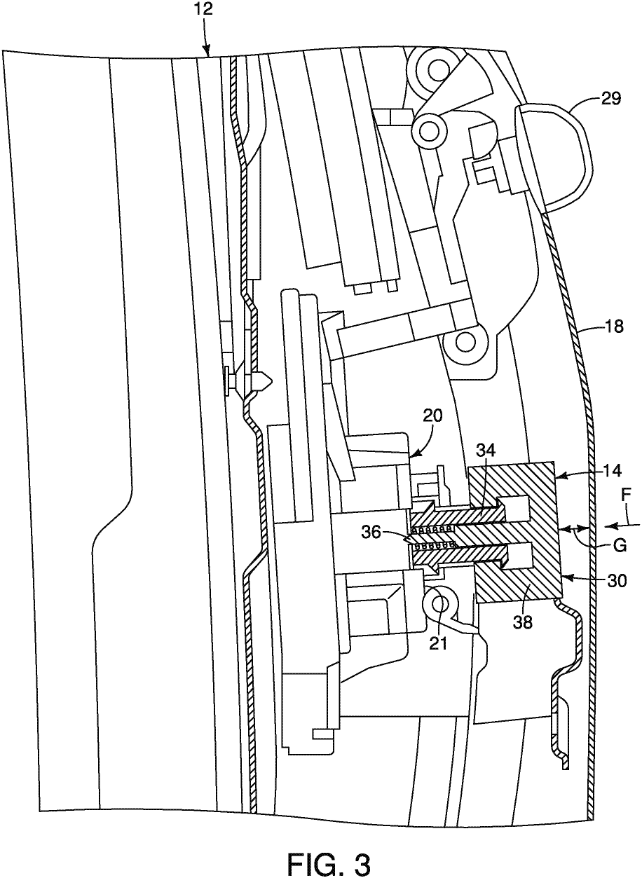

The vehicle door assembly 12 (hereinafter the door assembly 12) has an outer door panel 18 with a latch mechanism 20 installed within the door assembly 12. The door assembly 12 is installed to the vehicle 10 in a conventional manner for movement between a door closed orientation and a door open orientation. The latch mechanism 20 is preferably fixed to the door assembly 12 in a conventional manner via mechanical fasteners (not shown). As shown in FIG. 3, the latch mechanism 20 is installed to the door assembly 12 inboard of the outer door panel 18.

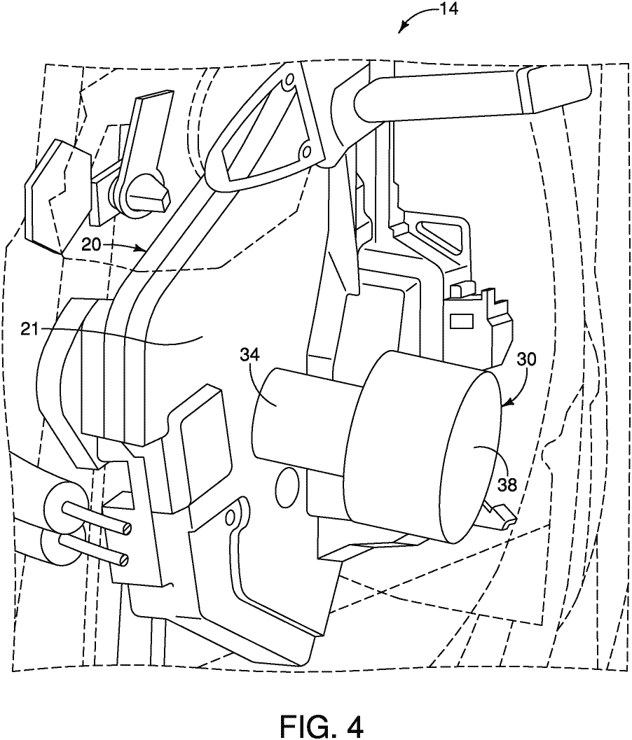

As shown in FIGS. 3 and 4, the door latch jamming assembly 14 includes the latch mechanism 20 and a jamming mechanism 30. The latch mechanism 20 has an outboard surface 21 with the jamming mechanism 30 being attached to the outboard surface 21. As shown in FIG. 3, a distal end (or button end) of the jamming mechanism 30 is spaced apart from the outer door panel 18 defining a gap G therebetween.

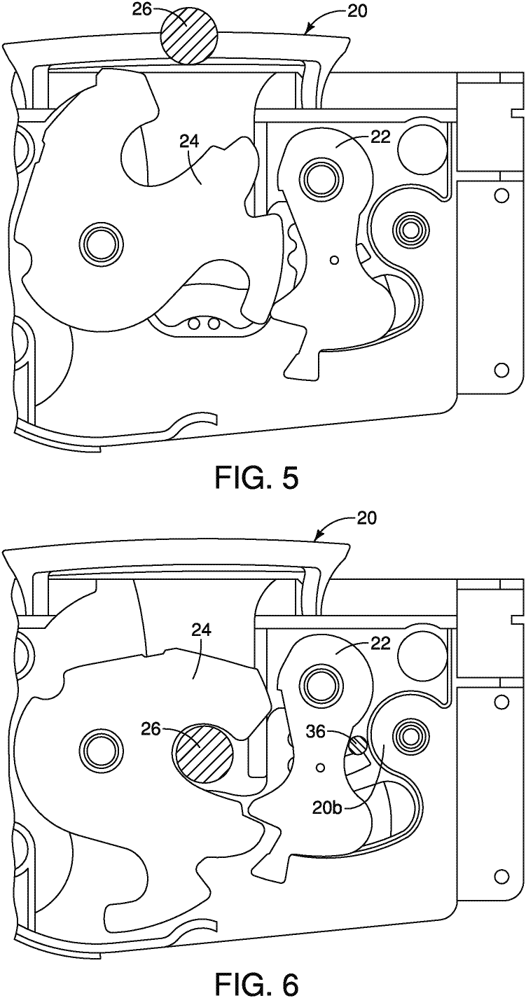

As shown in FIGS. 5 and 6, the latch mechanism 20 includes at least a first movable member 22 and a second movable member 24. The first moveable member 22 is referred to as often referred to as a cooperating detent and the second movable member 24 is often referred to as a forkbolt in the art. The first moveable member 22 is spring biased (spring not shown) to move from the door closed orientation shown in FIG. 6 to the door open orientation shown in FIG. 5. In the door open orientation, a striker 26 that is fixed to a B-pillar 28 of the vehicle 10 is released from engagement with the second moveable member 24 such that the door assembly 12 can open.

When the door assembly 12 is moved to the closed orientation shown in FIGS. 1, 2 and 6, the second movable member 24 pivots to the door closed orientation shown in FIG. 6, trapping the striker 26 and keeping the door assembly 12 closed. The first movable member 22 of the latch mechanism 20 is also spring biased (spring not shown) to move to the orientation shown in FIG. 6, thus interfering with pivoting movement of the second movable member 22 and keeping the door assembly 12 in the closed position. In order to open the door, a door handle mechanism 29 of the door assembly 12 is operated in a convention manner. Movement of the handle mechanism 29 (via a cable) causes movement of the first movable member 22 from the door closed orientation shown in FIG. 6 to the door open orientation shown in FIG. 5, where the second movable member 22 is release and free to move. Since the internal workings of a door latch mechanisms such the door latch mechanism 20 and the striker 26 are conventional devices well known in the art, further description is omitted for the sake of brevity.

As shown in FIGS. 3, 7 and 8, the jamming mechanism 30 installed to the outboard surface 21 of the latch mechanism 20. The jamming mechanism 30 has a housing 34, a pin or jamming member 36 and an end portion 38. In the first embodiment, the jamming member 36 and the end portion 38 can be formed together as a single, unitary, monolithic element, or can be two separate elements directly attached one another, or, can be otherwise coupled to one another such that they move together as a single element.

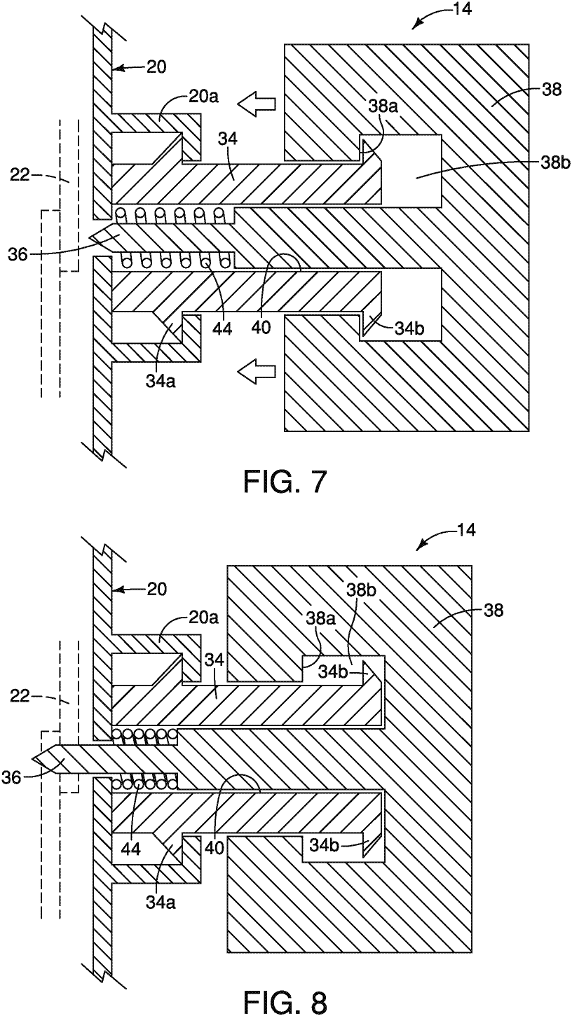

The housing 34 has a hollow interior 40. As shown in FIGS. 7 and 8, the jamming member 36 extends into and through the hollow interior 40 of the housing 34. The end portion 38 is basically a large button that extends away from the latch mechanism 20 and toward the outer door panel 18, as shown in FIG. 3. As mentioned above, the gap G is defined between an outboard surface of the end portion 38 and an inboard surface of the outer door panel 18. The jamming member 36 (and the end portion 38) are biased by a spring 44 to move away from the latch mechanism 20.

As shown in FIGS. 7 and 8, the housing 34 of the jamming mechanism 30 includes a first movement limiting projection 34a (or projections 34a) that prevent the housing 34 from moving in an outboard direction from an attachment portion 20a of the latch mechanism 20. The housing 34 also includes a second movement limiting projection 34b (or projections 34b) that are positioned to prevent movement of the end portion 38 outboard, as shown in FIG. 7. The end portion 38 includes a limiting structure 38a and a hollow interior 38b. The limiting structure 38a is a radially inwardly extending protrusion that engages the projection 34b of the housing 34 limiting outboard movement of the end portion 38. The hollow interior 38b that is dimensioned such that when the end portion 38 is moved in an inboard direction toward the latch mechanism 20, the area of the housing 34 with the projections 34b has a predetermined space to be retained in within the moving end portion 38.

In response to an impact event where impacting forces F (FIG. 3) press the outer door panel 18 against the end portion 38, the forces F will deform the outer door panel 18 causing the outer door panel 18 to press against the end portion 38 toward the latch mechanism 20. Since the end portion 38 and the jamming member 36 move as a single element, the jamming member 36 is also moved by the end portion 38 into an interior of the latch mechanism 20 preventing the first movable member 22 of the latch mechanism 20 from moving away from the door closed orientation.

When impacting forces F (FIG. 3) push the end portion 38, the jamming member 36 (a pin or small shaft) is moved through an opening in the latch mechanism 20 and into a space between the first moveable member 22 a housing features 20b preventing movement of the first moveable member 22, as shown in FIG. 5. Since the first moveable member 22 cannot move under these circumstances, the second moveable member 24 is also prevented from moving making the release of the striker 26 extremely different.

Thus, movement of the end portion 38 and the jamming member 36 in an inboard direction such that the jamming member 36 is pushed into the latch mechanism 20 prevents door opening movements of the first and second moveable members 22 and 24. In other words, pushing on the end portion 38 prevents the door assembly 12 from opening.

In the depicted embodiments, the gap G between the end portion 38 of the jamming mechanism 30 and the inboard surface of the outer door panel 18 is necessary so that the outer door panel 18 can absorb through deformation small amounts of impacting forces F before pressing on the jamming mechanism 30. Therefore, in a minor impact event, the jamming mechanism 30 is not operated and does not move to prevent the door assembly 12 from opening.

Therefore, in the first embodiment, the jamming member 36, the housing 34 and the end portion 38 are preferably designed when specific dimensions such that the gap G is ensured to be within predetermined tolerances. As is shown in the second and third embodiments, it is possible to provide a jamming mechanism 30 that can be adjusted to ensure a desired size of the gap G.

It should be understood from the drawings and the description herein that the attachment between the attachment portion 20a and the latch mechanism 20 can include any of a variety of attachment configurations. For example, the attachment portion 20a can be threadedly attached to the latch mechanism 20 or can include mechanical fasteners. Further, although not shown, the housing 34 can be divided into two separate members that threadedly connect to one another or snap fit to one another during assembly of the jamming assembly 14.

### Second Embodiment

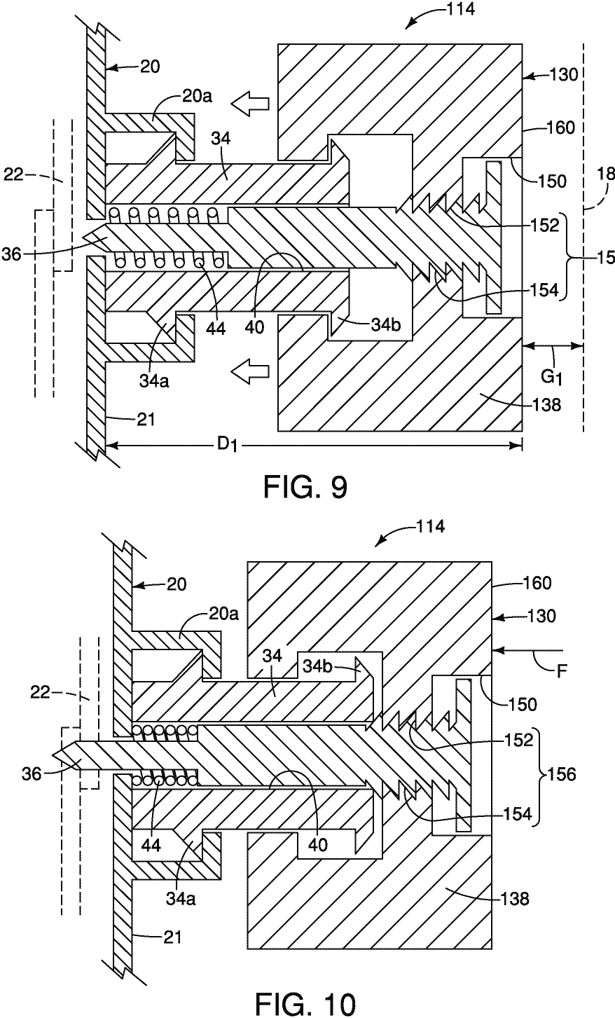

Referring now to FIGS. 9, 10 and 11, a jamming assembly 114 with a jamming mechanism 130 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

In the second embodiment, the jamming mechanism 130 basically includes many of the elements of the jamming mechanism 130, with some modifications. Specifically, the jamming mechanism 130 includes the latch mechanism 20, the attachment portion 20a, the housing 34 with projections 34a and 34b and hollow interior 40 and the spring 44, all identical to that disclosed in the first embodiment. However, in the second embodiment the jamming member 36 and the end portion 38 of the first embodiment are replaced with a jamming member 136 and an end portion 138.

FIG. 9 shows the jamming member 136 and the end portion 138 biased to their outboard most at rest position. FIG. 10 shows the jamming member 136 and the end portion 138 pushed in an inboard direction such that the jamming member 136 interferes with the first moveable member 22 preventing the latch mechanism 20 from opening the door assembly 12.

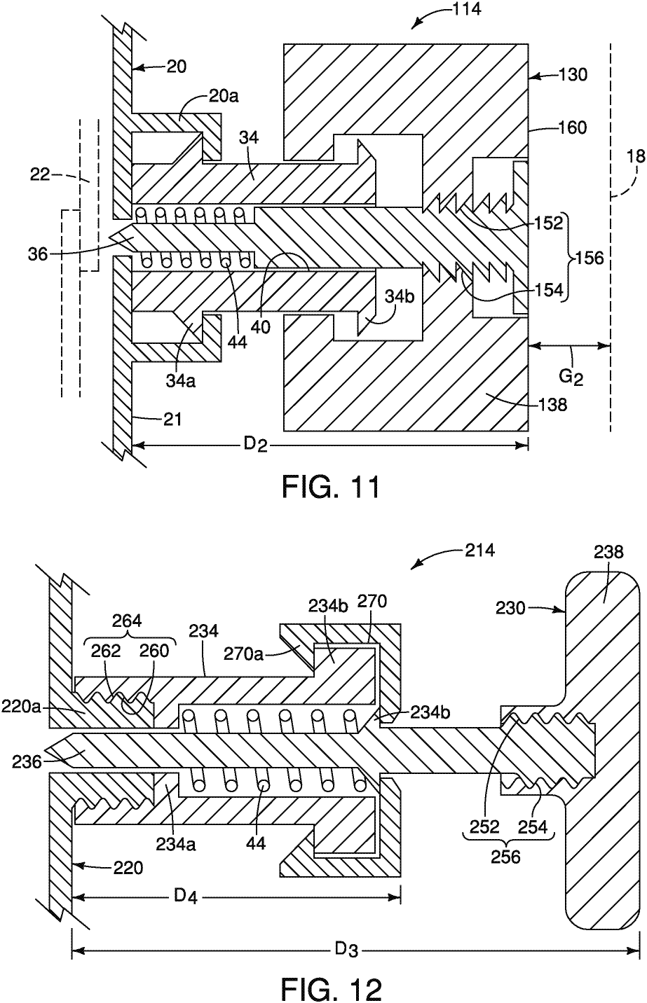

FIG. 11 shows the end portion 138 after having been adjusted relative to the jamming member 136, as is described further below.

The jamming member 136 and the end portion 138 are separate elements. The end portion 138 includes an opening with inner threads 152 and the jamming member 136 has outer threads 154 that engage the inner threads 152 of the end portion 138. Together, the inner threads 152 and the outer threads 154 define an adjustment structure 156 or adjustment features 156. More specifically, the adjustment structure 156 provides a means for adjusting a distance D₁ between an outboard end surface 160 of the end portion 138 and the outboard surface 21 of the latch mechanism 20. In FIG. 11, the distance D₂ is not the same as the distance D₁ in FIG. 9 due to the rotation of the end portion 138 about the threads 154 of the jamming member 136. The adjustment features 156 is more specifically employed to adjust the size of the gap between the outboard end surface 160 of the end portion 138 and an inboard surface of the outer door panel 18. The gap G₁ in FIG. 9 is not the same as the gap G₂ in FIG. 11 with the end portion 138 and the jamming member 136 urged by the spring 44 to their respective outboard-most positions.

### Third Embodiment

Referring now to FIGS. 12, 13 and 14, a jamming assembly 214 with a jamming mechanism 230 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

In the third embodiment, the jamming mechanism 30 has been modified to achieve the jamming mechanism 230. The jamming mechanism 230 of the third embodiment includes a latch mechanism 220, an end portion 238, a housing 234 with a hollow interior, the spring 44 and a jamming member 236. The end portion 238 and the jamming member 236 are connected to one another via mechanical threads 252 and 254, respectively. The threads 252 and 254 define a first adjustment structure 256. The housing 234 and the latch mechanism 220 are connected to one another via mechanical threads 260 and 262, respectively. The threads 260 and 262 define a second adjustment structure 264.

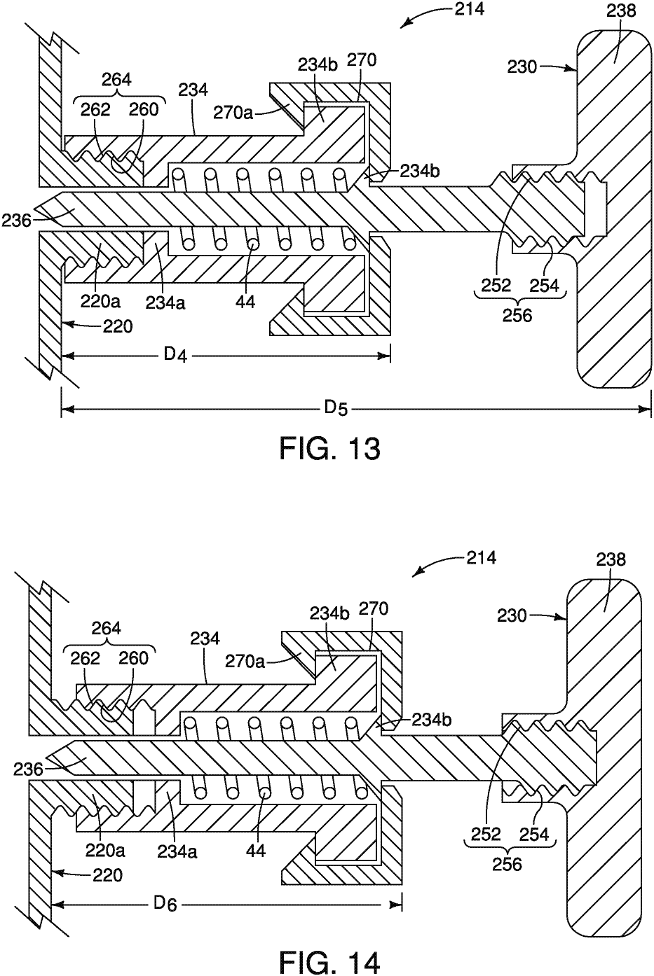

FIG. 12 shows the jamming member 236 and the end portion 238 biased to their outboard most at rest position by the spring 44. As shown in FIG. 12, the jamming member 236 and the end portion 238 are separate elements. The relative position of the portion 238 relative to the jamming member 236 can be adjusted via operation of the first adjustment structure 256. Specifically, by rotating the end portion 238 about the jamming member 236, the size of the distance D₃ can be lengthened or shortened to achieve the distance D₅ shown in FIG. 13.

As well, by rotating the housing 234 relative to the threads 262 of the latch mechanism 220 (operating the second adjustment structure 264) the distance D₄ shown in FIGS. 12 and 13 can be altered to achieve the distance D₆ shown in FIG. 14.

Operation of the first adjustment structure 256 provides a way of fine tuning the size of the gap between the outboard end of the end portion 238 and the outer door panel 18 (not shown in FIGS. 12-14). Operation of the second adjustment structure 264 also aids in the adjustment of the gap, but also provides a way of positioning the distal end of the jamming member 236 relative to latch mechanism 220. Such adjustments can be necessary in vehicles where size of the doors and/or location of the latch mechanism is such that the gap G is too big or too small when the jamming mechanism 30 of the first embodiment is employed.

To be clear, FIGS. 12 and 13 show the distances D₃ and D₅, respectively. The first adjustment structure 256 is used to change the distance D₃ to achieve the distance D₅. The distance D₅ can be larger or smaller than the distance D₃. Similarly, FIGS. 12 and 13 show the distance D₄. The second adjustment structure 264 is used to change the distance D₄ to achieve the distance D₆ shown in FIG. 14. The distance D₆ can be larger or smaller than the distance D₄.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the door latch jamming assembly. Accordingly, these terms, as utilized to describe the present invention should be interpreted relative to a vehicle equipped with the door latch jamming assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A door latch jamming assembly, comprising:
a vehicle door assembly having an outer door panel;
a latch mechanism having at least one member movable between a door closed orientation and a door open orientation, the latch mechanism being installed to the vehicle door assembly inboard of the outer door panel; and
a jamming mechanism installed to the latch mechanism, the jamming mechanism having, a jamming member and an end portion coupled to the jamming member, the end portion extending away from the latch mechanism toward the outer door panel such that in response to an impact event where impacting forces press the outer door panel against the end portion pushing the end portion toward the latch mechanism, the jamming member is also moved by the end portion into the latch mechanism preventing the member of the latch mechanism from moving away from the door closed orientation.

2. The door latch jamming assembly according to claim 1, further comprising
a housing having a hollow interior with the jamming member extending though the housing with the end portion being directly attached to the jamming member.

3. The door latch jamming assembly according to claim 2, wherein
the jamming member and the end portion are formed as a single monolithic element.

4. The door latch jamming assembly according to claim 2, wherein
the end portion and the jamming portion are coupled to one another via an adjustment feature such that a distance measured from a distal end of the jamming portion and to an outboard surface of the end portion can be adjusted.

5. The door latch jamming assembly according to claim 4, wherein
the housing and the latching mechanism are attached to one another via a second adjustment feature such that a distance between an outboard surface of the latching mechanism and an outboard end of the housing can be adjusted.

6. The door latch jamming assembly according to claim 4, wherein
the adjustment feature between the end portion and the jamming portion includes threaded engagement therebetween.

7. The door latch jamming assembly according to claim 1, wherein
the jamming member and the end portion are spring biased to move in a direction away from the latch mechanism.

8. The door latch jamming assembly according to claim 1, wherein
the end portion and the jamming portion are coupled to one another via an adjustment feature such that a distance measured from a distal end of the jamming portion and to an outboard surface of the end portion can be adjusted.

9. The door latch jamming assembly according to claim 8, wherein
the adjustment feature between the end portion and the jamming portion includes threaded engagement therebetween.

10. A door latch jamming assembly, comprising:
a vehicle door assembly having an outer door panel;
a latch mechanism having at least one member movable between a door closed orientation and a door open orientation, the latch mechanism being installed to the vehicle door assembly inboard of the outer door panel; and
a jamming mechanism installed to the latch mechanism, the jamming mechanism having, a housing, a jamming member and an end portion, the housing having a hollow interior, the jamming member that extending into the hollow interior of the housing and the end portion being coupled to the jamming member within the housing, the end portion extending away from the latch mechanism toward the outer door panel such that in response to an impact event where impacting forces press the outer door panel against the end portion pushing the end portion toward the latch mechanism, the jamming member is also moved by the end portion into the latch mechanism preventing the member of the latch mechanism from moving away from the door closed orientation.

11. The door latch jamming assembly according to claim 10, wherein
the end portion is directly attached to the jamming member.

12. The door latch jamming assembly according to claim 10, wherein
the jamming member and the end portion are formed as a single monolithic element.

13. The door latch jamming assembly according to claim 11, wherein
the end portion and the jamming portion are attached to one another via an adjustment feature such that a distance measured from a distal end of the jamming portion and to an outboard surface of the end portion can be adjusted.

14. The door latch jamming assembly according to claim 13, wherein
the housing and the latching mechanism are attached to one another via a second adjustment feature such that a distance between an outboard surface of the latching mechanism and an outboard end of the housing can be adjusted.

15. The door latch jamming assembly according to claim 13, wherein
the adjustment feature between the end portion and the jamming portion includes threaded engagement therebetween.

16. The door latch jamming assembly according to claim 10, wherein
the jamming member and the end portion are spring biased to move in a direction away from the latch mechanism.

17. The door latch jamming assembly according to claim 10, wherein
the end portion and the jamming portion are coupled to one another via an adjustment feature such that a distance measured from a distal end of the jamming portion and to an outboard surface of the end portion can be adjusted.

18. The door latch jamming assembly according to claim 10, wherein
adjustment feature between the end portion and the jamming portion includes threaded engagement therebetween.
